(19) United States
(12) Patent Application Publication
(10) Pub. No.: US 2018/0366739 A1
(43) Pub. Date: Dec. 20, 2018

(54) METHOD FOR MANUFACTURING CATALYST LAYER AND APPARATUS FOR MANUFACTURING THE SAME

(71) Applicant: TOYOTA JIDOSHA KABUSHIKI KAISHA, Toyota-shi (JP)

(72) Inventors: Noritoshi OKA, Nagakute-shi (JP); Kazuki FUJII, Nagoya-shi (JP)

(21) Appl. No.: 16/004,886

(22) Filed: Jun. 11, 2018

(30) Foreign Application Priority Data
Jun. 16, 2017 (JP) 2017-118400

(51) Int. Cl. H01M 4/88

(52) U.S. Cl. CPC H01M 4/8828

(57) ABSTRACT

A sheet having undergone the process of applying catalyst ink onto at least part of a surface of a transported sheet to a predetermined thickness is dried so that a solvent evaporating from the catalyst ink is recovered, and the sheet having undergone the process of transferring a catalyst layer formed on the transported sheet after the solvent evaporates onto another member so that the catalyst layer is removed is cleaned by using the recovered solvent as cleaning liquid so that at least part of the residue of at least the catalyst ink left on the sheet is removed. The thus cleaned transported sheet, when the usage count thereof is smaller than or equal to a quality assurance count, is reused in the application of the catalyst ink. As a result, in the manufacture of the catalyst layer using the catalyst ink, the amount of emission toward the outside is reduced.

### CROSS-REFERENCE TO RELATED APPLICATION

The present application claims priority from Japanese application P2017-118400 filed on Jun. 16, 2017, the content of which is hereby incorporated by reference into this application.

### BACKGROUND

### 1. Field

The present disclosure relates to manufacture of a catalyst layer used in a membrane electrode assembly and the like.

### 2. Related Art

To manufacture a membrane electrode assembly (MEA) for a fuel cell, the following steps are employed in some cases: applying catalyst ink onto a sheet; drying the sheet; then transporting the sheet; and transferring the catalyst ink onto a solid electrolyte membrane. In this process, an attempt has been made to use the sheet onto which the catalyst ink has been applied as a transportation belt, recover the sheet after use without discarding the sheet, and reuse the sheet multiple times (see related document 1, for example). The related document 1 proposes that a dispersion solvent used in the catalyst ink also be recovered and reused.

### RELATED DOCUMENT

Related document 1: Japanese Patent Laid-Open No. 2010-049981

The technology described above excels in terms of the attempt to reuse the sheet and the dispersion solvent to reduce the amount of emission produced in the manufacturing steps. To actually reuse the sheet and the solvent, however, cleaning liquid for cleaning the sheet is required, and the cleaning liquid is, for example, eventually discharged in one of the manufacturing steps. Therefore, to achieve what is called zero emission, further improvement is required.

### SUMMARY

(1) First aspect of the present disclosure relates to a method for manufacturing at least a catalyst layer by using catalyst ink formed of a solid catalyst dispersed in a liquid solvent. The manufacturing method includes drying a sheet having undergone a process of applying the catalyst ink onto at least part of a surface of the sheet to a predetermined thickness to recover the solvent evaporating from the catalyst ink, cleaning the sheet having undergone the process of transferring a catalyst layer formed on the sheet after the solvent evaporates onto another member so that the catalyst layer is removed by using the recovered solvent as cleaning liquid to remove at least part of a residue of at least the catalyst ink left on the sheet, and using at least part of the cleaned sheet in the application of the catalyst ink.

Since the catalyst used in the catalyst ink can thus be used in the cleaning process, the cost of separately providing cleaning liquid and other materials used to clean the sheet can be reduced, and the amount of cleaning liquid discharged outside can also be reduced. Further, at least part of the sheet can be reused.

(2) A second aspect of the present disclosure claim relates to an apparatus that manufactures at least a catalyst layer by using catalyst ink formed of a solid catalyst dispersed in a liquid solvent. The apparatus includes a dryer/recovery apparatus that dries a sheet having undergone a process of applying the catalyst ink onto at least part of a surface of the sheet to a predetermined thickness to recover the solvent evaporating from the catalyst ink and a cleaner that cleans, by using the recovered solvent as cleaning liquid, the sheet to remove at least part of a residue of at least the catalyst ink left on the sheet, the sheet having undergone a process of transferring a catalyst layer formed on the sheet after the solvent evaporates onto another member to remove the catalyst layer, and at least part of the cleaned sheet is reused in the application of the catalyst ink.

The manufacturing apparatus allows the solvent used in the catalyst ink to be used in the cleaning process. Further, the cost of separately providing cleaning liquid and other materials used to clean the sheet can be reduced, and the amount of cleaning liquid discharged outside can also be reduced. Moreover, at least part of the sheet can be reused.

### BRIEF DESCRIPTION OF THE DRAWINGS

FIG. 1 is a descriptive diagram showing an overview of manufacture of a catalyst layer.

FIG. 2 is a schematic configuration diagram showing an example of a configuration of a dryer/recovery apparatus that dries and recovers a solvent.

FIG. 3 is a schematic configuration diagram showing an example of a configuration of a sheet cleaner.

FIG. 4 is a step diagram showing an overview of a method for manufacturing (part of) an MEA.

FIG. 5 is a descriptive diagram for describing a test that allows determination of a criterion in accordance with which whether a transported sheet can be reused.

FIG. 6 is a step diagram showing an example of the step of preparing a catalyst transfer sheet.

FIG. 7 is a step diagram showing an example of the step of transferring a catalyst layer.

### DETAILED DESCRIPTION OF THE PREFERRED EMBODIMENTS

### A. Overview of Method for Manufacturing Catalyst Layer

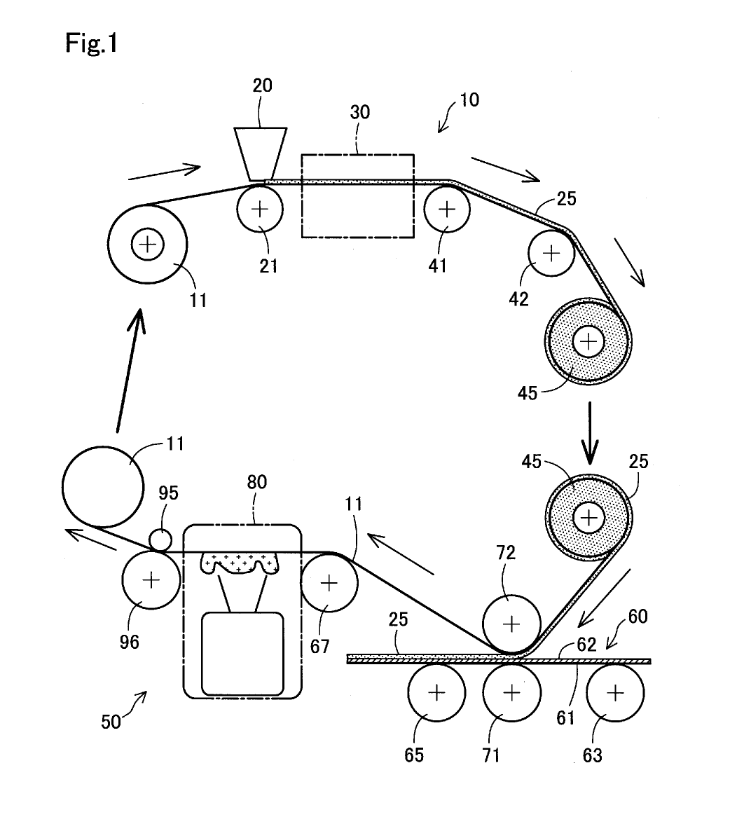

FIG. 1 is a descriptive diagram showing part of a method for manufacturing a membrane electrode assembly for a fuel cell. In FIG. 1, the upper portion shows the steps of forming a catalyst layer 25 on a transported sheet 11 and winding the transported sheet 11 into a roll of catalyst transfer sheet 45, and the lower portion shows the steps of transferring the catalyst layer 25 on the catalyst transfer sheet 45 onto an electrolyte membrane 62, and then recovering the transported sheet 11 used to form the catalyst transfer sheet 45. An apparatus that carries out the steps shown in the upper portion in FIG. 1 is called a catalyst transfer sheet preparation apparatus 10. An apparatus that carries out the steps shown in the lower portion in FIG. 1 is called a catalyst layer transfer apparatus 50.

### A1. Configuration of Catalyst Transfer Sheet Preparation Apparatus

In the catalyst transfer sheet preparation apparatus 10, the transported sheet 11 in the form of a roll is unreeled and transported to a coater 20. The coater 20 stores catalyst ink for forming a catalyst layer and coats the catalyst ink to a predetermined thickness onto the transported sheet 11 transported through the gap between the coater 20 and a coater roller 21. The transported sheet 11 is handled in the form of a roll of a long belt in this example but is not necessarily wound into a roll. Further, the transported sheet 11 is not necessarily a long sheet and may be a support film that supports the catalyst layer.

In the case where the transported sheet 11 is used as the belt, the transported sheet 11 is preferably made of an arbitrary layer material that is not readily deformed and excels in the ability to release a catalyst material. Preferable examples of a commercially available material of the transported sheet 11 include PTFE glass cloth (such as “VALFLON glass cloth” manufactured by NIPPON VALQUA INDUSTRIES, LTD. and “TG cloth” manufactured by Yodogawa Hu-Tech Co., Ltd.) and PTFE-coated polyimide sheet (such as FPI series manufactured by CHUKOH CHEMICAL INDUSTRIES, LTD.). The transported sheet 11 may instead be made of polytetrafluoroethylene, polyvinyl difluoride (PVDF), polyethylene, polyethylene terephthalate (PET), polyethylene naphthalate (PEN), polypropylene, polyester, polyamide, copolyamide, polyamide elastomer, polyimide, polyurethane, polyurethane elastomer, silicone, silicone rubber, silicon-based elastomer, or any other film material.

In the case where the transported sheet is used as the support film, preferable examples of a commercially available material of the support film may include PTFE glass cloth (such as “VALFLON glass cloth” manufactured by NIPPON VALQUA INDUSTRIES, LTD. and “TG cloth” manufactured by Yodogawa Hu-Tech Co., Ltd.) and PTFE-coated polyimide sheet (FPI series manufactured by CHUKOH CHEMICAL INDUSTRIES, LTD.). The transported sheet may instead be formed, for example, of a laminate base formed of two or more of the following films: a polyethylene film; a polypropylene film; a polytetrafluoroethylene film; an ethylene/tetrafluoroethylene copolymer film; a tetrafluoroethylene/perfluoro(alkyl vinyl ether) copolymer film; a polyvinylidene fluoride film; a polyimide film; a polyamide film; and a polyethylene terephthalate film or a Teflon sheet (Teflon: registered trademark of DuPont) as a commercially available material.

The transported sheet 11 is provided in the form of a roll in the present embodiment and loaded and used in the catalyst transfer sheet preparation apparatus 10.

The catalyst ink used in the coater 20 in the present embodiment is manufactured by mixing an electrically conductive carrier (such as particulate carbon carrier) carrying platinum, a platinum alloy, or any other catalyst, an electrolyte, such as Nafion (registered trademark, manufacture by DuPont) and Flemion (registered trademark, manufacture by Asahi Glass Co., Ltd.), and a solvent (organic solvent). The mixing operation is also called the step of manufacturing a catalyst ink. The catalyst particles are held so as to be dispersed in the solvent. The solvent is therefore hereinafter also referred to as a dispersion solvent. The dispersion solvent may be, for example, any one of water, isopropanol, ethanol, 1-propanol, 1-butanol, 2-butanol, ethylene glycol, propylene glycol, cyclohexanol, 2-methylcyclohexanol, acetic acid, propionic acid, and butanoic acid or the combination of a plurality thereof. Any other catalyst and any other dispersion solvent may naturally be combined with each other and used as the catalyst ink.

The catalyst ink may be continuously or intermittently applied onto the transported sheet 11. The thickness of the applied catalyst ink can be adjusted, for example, in accordance with the separation distance between the transported sheet 11 and the coater 20 and the pressure at which the catalyst ink is discharged. The thickness of the applied catalyst ink may be measured, and the separation distance, the discharge pressure, and other factors may be feedback controlled so that a fixed thickness is achieved.

After the coater 20 applies the catalyst ink onto the transported sheet 11, the transported sheet 11 is transported to a dryer/recovery apparatus 30. The dryer/recovery apparatus 30 is an apparatus that evaporates the solvent in the catalyst ink applied onto the transported sheet 11 and dries the catalyst ink. The dryer/recovery apparatus 30 evaporates the dispersion solvent in the catalyst ink and dries the catalyst ink. As a result, the catalyst layer 25 is formed on the surface of the transported sheet 11. At this point, the evaporated dispersion solvent is recovered.

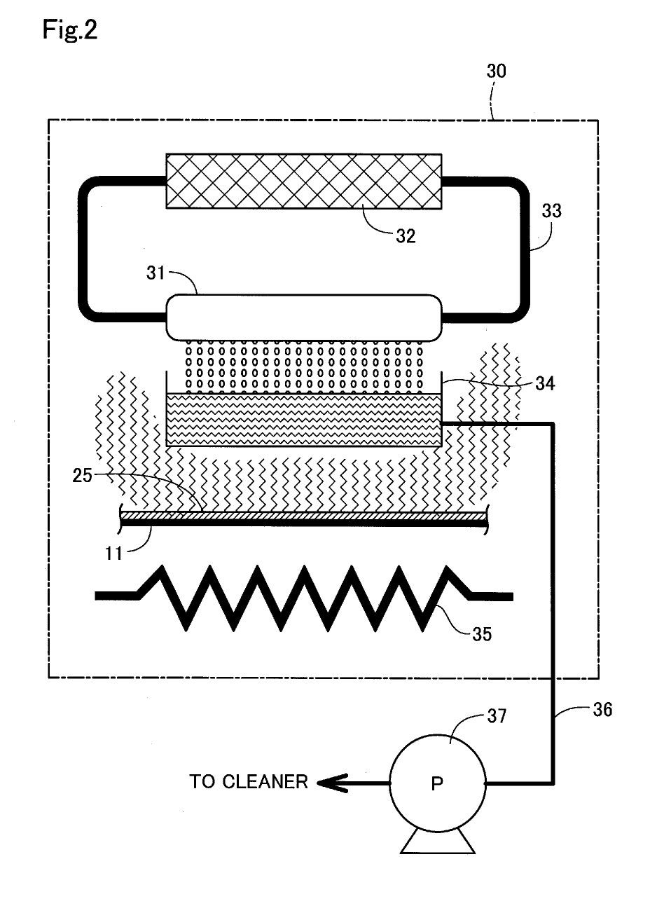

FIG. 2 shows an example of the structure of the dryer/recovery apparatus 30. The dryer/recovery apparatus 30 includes a drying heater 35 located below a path along which the transported sheet 11 is transported and further includes a cooling tube 31 and a cooling tower 32, through which a coolant circulates and are located above the transportation path, and a circulation path 33, which connects the cooling tube 31 and the cooling tower 32 to each other and is also located above the transportation path. The coolant in the circulation path 33 is circulated by a pump that is not shown. The dryer/recovery apparatus 30 further includes a receiver 34, which is located below the cooling tube 31, and a pump 37, which recovers the dispersion solvent stored in the receiver 34 via a recovery passage 36.

In the dryer/recovery apparatus 30, the dispersion solvent contained in the catalyst ink on the transported sheet 11 having been transported into the dryer/recovery apparatus 30 evaporates when heated by the heater 35. The evaporated dispersion solvent is cooled by the cooling tube 31 to a temperature lower than or equal to the dew point of the solvent so that the dispersion solvent liquefies, accumulates on the surface of the cooling tube 31, and then drops, and accumulates in the receiver 34. In FIG. 2, the cooling tower 32 is drawn so as to be located in the dryer/recovery apparatus 30. The cooling tower 32 may instead be provided in a position thermally separate from the dryer/recovery apparatus 30. The heater 35 is not necessarily provided in a case where the dispersion solvent evaporates at about room temperature. Instead, the heater 35 may be replaced with a configuration that blows warm or hot air into the dryer/recovery apparatus 30. The heat dissipated via the cooling tower 32 may be recovered with a heat exchanger and used to heat the catalyst ink. In a case where the recovered heat is not enough to heat the catalyst ink, a heat pump or any other component may be used to raise the temperature of the catalyst ink.

In any case, the dryer/recovery apparatus 30 only needs to achieve a temperature at which the catalyst ink on the transported sheet 11 evaporates and dries by at least a fixed amount by the time when the transported sheet 11 is transported out of the dryer/recovery apparatus 30. The dispersion solvent that evaporates from the catalyst ink in the drying process may not be fully recovered. Further, the catalyst ink may not be fully dried by the dryer/recovery apparatus 30. In this case, warm air may be further blown onto the transported sheet 11 having been transported out of the dryer/recovery apparatus 30 to dry the catalyst ink, or the catalyst ink may be further allowed to naturally dry.

The transported sheet 11 having been transported out of the dryer/recovery apparatus 30 is further transported by transportation rollers 41 and 42 and wound along with the catalyst layer 25 formed in the drying process as the catalyst transfer sheet 45. The catalyst transfer sheet 45 wound in the form of a roll is loaded into the catalyst layer transfer apparatus 50 at a predetermined timing. The catalyst layer transfer apparatus 50 is an apparatus that transfers the catalyst layer onto the electrolyte membrane 62.

### A2. Configuration of Catalyst Layer Transfer Apparatus

In the catalyst layer transfer apparatus 50, an electrolyte membrane sheet 60, which is formed of a back sheet 61 on which the electrolyte membrane 62 has been formed, is provided. Preferable examples of a commercially available material of the back sheet 61 include PTFE glass cloth (such as “VALFLON glass cloth” manufactured by NIPPON VALQUA INDUSTRIES, LTD. and “TG cloth” manufactured by Yodogawa Hu-Tech Co., Ltd.) and PTFE-coated polyimide sheet (such as FPI series manufactured by CHUKOH CHEMICAL INDUSTRIES, LTD.). The back sheet 61 may instead be formed of a polymer sheet made, for example, of polytetrafluoroethylene (PTFE), PET (polyethylene terephthalate), PEN (polyethylene naphthalate), or any other polyester-based material or polystyrene. The electrolyte membrane 62 is a proton-conductive ion exchange membrane made of a solid polymer material, such as fluorine-based resin, and has satisfactory electric conductivity in a wet condition. The electrolyte membrane sheet 60 is formed by using a polymer electrolyte resin that forms the electrolyte membrane 62 so as to have a long shape along the surface of the back sheet 61. The electrolyte membrane sheet 60 may be provided in the form of a roll along with the back sheet 61, or the electrolyte membrane sheet 60 produced in a pre-process may be used as it is.

The electrolyte membrane sheet 60 is transported by transportation rollers 63 and 65 and sent along with the catalyst transfer sheet 45 unreeled by an unreeling mechanism that is not shown to transfer rollers 71 and 72. The transfer rollers 71 and 72 face each other, and pressing force for causing the two rollers to be in contact with each other acts on the two rollers. The portion where the two rollers 71 and 72 are in contact with each other (nip section) forms a transfer/pressure contact portion. The transfer rollers 71 and 72 rotate in opposite directions under the control of a controller that is not shown, bring the catalyst transfer sheet 45 and the electrolyte membrane sheet 60 to the transfer/pressure contact portion with the catalyst layer 25 and the electrolyte membrane 62 being in contact with each other, transfer the catalyst layer 25 on the catalyst transfer sheet 45 onto the electrolyte membrane 62 on the electrolyte membrane sheet 60, and transport the two sheets downstream.

The transfer roller 71 is formed of a roller made of a heat transmissible metal, for example, a roller made of a nickel-based metal and is heated by a heat source that is not shown. The transfer roller 71 heats the electrolyte membrane sheet 60 and the catalyst transfer sheet 45 that is in contact therewith via the back sheet 61 and presses along with the transfer roller 72 the two sheets. The heating of the transfer roller 71 and the pressing force produced by the two rollers 71 and 72 are controlled by the controller.

The heating and pressurizing operation performed by the transfer rollers 71 and 72 allows the catalyst layer 25 on the catalyst transfer sheet 45 to be transferred onto the electrolyte membrane 62 on the electrolyte membrane sheet 60. The electrolyte membrane sheet 60 onto which the catalyst layer 25 has been transferred is transported by a transportation roller 65 and sent to a post-process. On the other hand, the catalyst transfer sheet 45 returns to the original transported sheet 11 as a result of the transfer of the catalyst layer 25 onto the electrolyte membrane sheet 60. The transported sheet 11 is sent into a cleaner 80 via a transportation roller 67.

The cleaner 80 is an apparatus that cleans the transported sheet 11 after the catalyst layer 25 is transferred onto the electrolyte membrane sheet 60. Although the transported sheet 11 has high releasability so that the catalyst layer 25 is transferred onto the electrolyte membrane sheet 60, some of residue of the catalyst layer 25 is left on the transported sheet 11 in some cases. The cleaner 80 cleans the transported sheet 11 to remove the residue of the catalyst layer 25 from the transported sheet 11. The transported sheet 11 from which the residue of the catalyst layer 25 has been removed is transported by transportation rollers 95 and 96, eventually wound, and reused to produce the catalyst transfer sheet 45 in the catalyst transfer sheet preparation apparatus 10 described above.

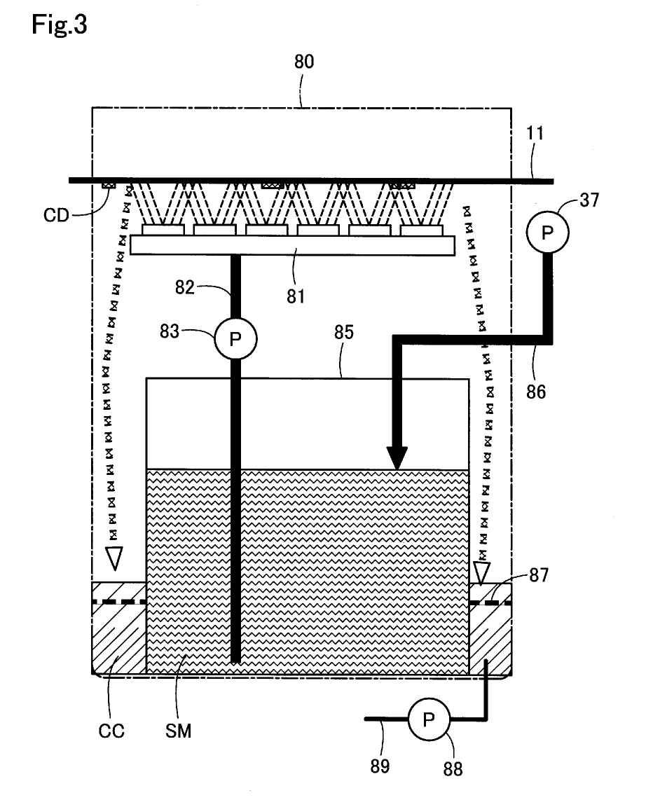

FIG. 3 shows the internal configuration of the cleaner 80. The cleaner 80 includes a shower head 81, which blows cleaning liquid in the form of a dispersion solvent onto the transported sheet 11, a solvent tank 85, which stores a dispersion solvent SM recovered by the dryer/recovery apparatus 30 and supplied by the pump 37 through a supply passage 86, a pump 83, which feeds under pressure the dispersion solvent SM stored in the solvent tank 85 to the shower head 81 via a solution passage 82, wire netting 87, which separates a catalyst CC contained in the dispersion solvent SM sprayed out of the shower head 81 from the dispersion solvent SM, a pressure feed pump 88, which recovers the catalyst CC having been contained in the recovered liquid having accumulated at the bottom of the cleaner 80 but having passed through the wire netting 87 via a passage 89, and other components. In the present embodiment, the bottom of the cleaner 80 is directly used as the storage tank that stores the dispersion solvent.

In the cleaner 80, the shower head 81 is provided so as to cover the width of the transported sheet 11 (direction perpendicular to the plane of FIG. 3), and the dispersion solvent SM is sprayed out of the shower head 81 by the pressure produced by the pump 83 and washes off a residue CD of the catalyst layer 25 left on the transported sheet 11. The washed-off residue of the catalyst layer 25 accumulates at the bottom of the cleaner 80 along with the sprayed dispersion solvent. The recovered liquid having accumulated at the bottom contains the catalyst CC originating from the catalyst layer 25 and the dispersion solvent SM, and the catalyst CC, which deposits and accumulates at the bottom, is recovered by the pressure feed pump 88 through the passage 89, which communicates with the bottom. The dispersion solvent SM having accumulated at the bottom can be drawn up by a pump that is not shown but is located above the wire netting 87, and the drawn dispersion solvent SM then reused.

A description will be made of a method for manufacturing a membrane electrode assembly for a fuel cell carried out by assuming the apparatus configuration described above. The manufacturing method relates to manufacture of at least a catalyst layer and includes the step of transferring the catalyst layer onto at least one side of an electrolyte membrane to manufacture part of the membrane electrode assembly.

### B. Step of Manufacturing Membrane Electrode Assembly

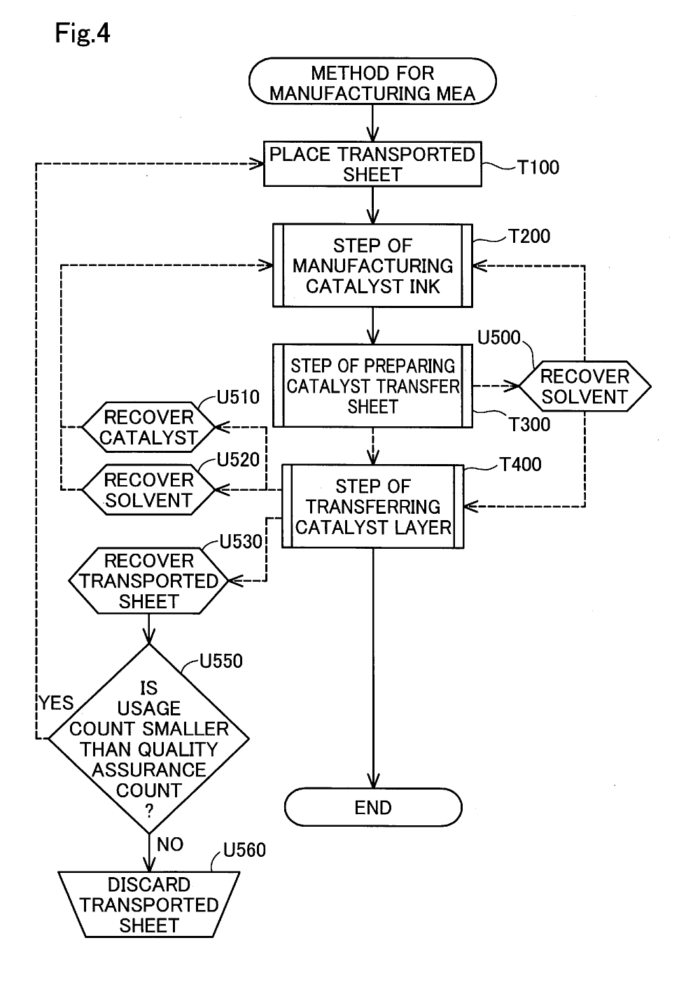

Step of manufacturing membrane electrode assembly is a part of the manufacturing steps. FIG. 4 is a step diagram showing an overview of the method for manufacturing part of a membrane electrode assembly (MEA). The manufacturing steps start from the step of providing the transported sheet 11 (step T100), and the catalyst ink is then manufactured (step T200). Either step T100 or step T200 may be carried out first. The step of preparing a catalyst transfer sheet (step T300) is then carried out. Step T300 is carried out by the catalyst transfer sheet preparation apparatus 10 described with reference to FIGS. 1 and 2. The catalyst transfer sheet 45 prepared in the step of preparing a catalyst transfer sheet is loaded in the catalyst layer transfer apparatus 50 shown in FIG. 1 and undergoes the step of transferring a catalyst layer (step T400). The step of transferring a catalyst layer (step T400) allows manufacture of part of the membrane electrode assembly (MEA) formed of a cathode-side catalyst layer 25 transferred at least on one side of the electrolyte membrane 62. After the manufacture, the method proceeds to “END,” and the entire steps described above end.

Part of the steps of manufacturing a membrane electrode assembly has been described. In the present embodiment, the dispersion solvent, the catalyst, and the transported sheet 11 are recovered and reused in these steps. In FIG. 4, the procedure of the reuse is indicated by the broken lines. That is, in the step of preparing a catalyst transfer sheet (step T300), the dispersion solvent contained in the catalyst ink is recovered by the dryer/recovery apparatus 30 (step U500). The thus recovered dispersion solvent is sent by the pump 37 to the cleaner 80 and used to clean the transported sheet 11 in the step of transferring a catalyst layer (step T400). Part of the dispersion solvent recovered in the step of preparing a catalyst transfer sheet (step T300) may be directly used to manufacture the catalyst ink in the step of manufacturing a catalyst ink.

In the step of transferring a catalyst layer (step T400), the catalyst washed off in the process of cleaning the transported sheet 11 is recovered by the cleaner 80 (step U510), the dispersion solvent used in the process of cleaning the transported sheet 11 is recovered (step U520), and the transported sheet 11 is further recovered (step U530). Among the recovered items, the recovered catalyst and dispersion solvent are returned as appropriate to the step of manufacturing a catalyst ink (T200) and used to manufacture the catalyst ink. Since the recovered catalyst and dispersion solvent are used to manufacture the catalyst ink, the amount of emission produced in the manufacturing steps can be reduced. Since the catalyst is, of course, lost by a predetermined proportion in the manufacturing steps and so is the dispersion solvent, the lost catalyst and dispersion solvent are newly replenished.

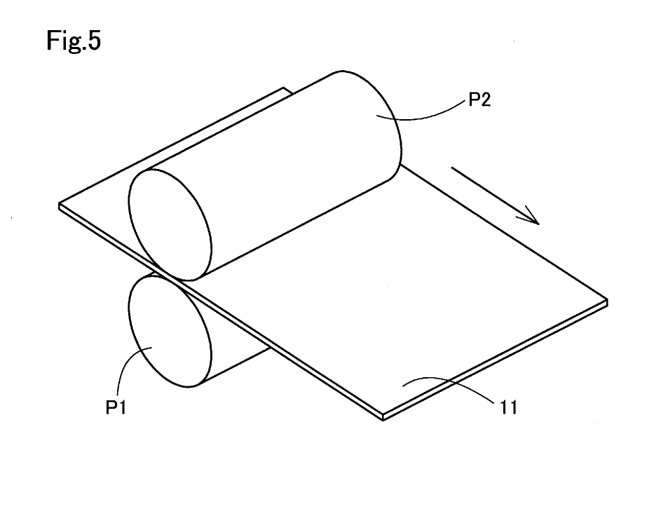

On the other hand, the recovered transported sheet 11 is reused after the recovery, and usage count of the transported sheet 11 is recorded. It is then evaluated whether the usage count of the transported sheet 11 is smaller than or equal to a quality assurance count (step U550). The quality assurance count is determined in advance in accordance with the nature of the transported sheet 11. For example, assume that the cathode-side catalyst layer 25 is transferred onto the electrolyte membrane 62 at a temperature higher than or equal to 130° C. but lower than or equal to 150° C., the change in the dimension of the transported sheet 11 that occurs at a transfer temperature within the range described above is smaller than or equal to 0.6%, and the water contact angle is greater than 95 degrees. In this case, the transported sheet 11 can be reused up to about 100 times with the quality thereof assured. The quality assurance count may thus be determined in advance based on a result of a test of the change in the dimension of the transported sheet at the transfer temperature. The test is carried out by using heated pressing rollers P1 and P2 as follows, as shown, for example, in FIG. 5: The temperature of the heated pressing rollers P1 and P2 is heated to the transfer temperature (150° C., for example); the transported sheet is transported at a transportation speed of 16 m/min; the transportation is repeated by N times; and the amount of change in the dimension is measured. The count N immediately before the amount of change exceeds 0.6% may be used as the quality assurance count. PTFE coat glass cloth and the PTFE coat polyamide were tested under the conditions described above, and the result of the test shows that the quality assurance count is greater than 100, which means that the two materials have very good reusability. Setting the quality assurance count at a value smaller than 100 allows use of a sheet made of a different material, such as Teflon and PFA. The quality assurance count may be determined based not only on the amount of change in the dimension but on an additional condition from the viewpoint of how easily the catalyst peels off the transported sheet, for example, in the case where the water contact angle is greater than 95 degrees.

In a case where the usage count is smaller than or equal to the quality assurance count (“YES” in step U550), the transported sheet 11 is returned to the step of placing the transported sheet 11 (step T100), whereas in a case where the usage count is greater than the quality assurance count (“NO” in step U550), the transported sheet is discarded (step U560).

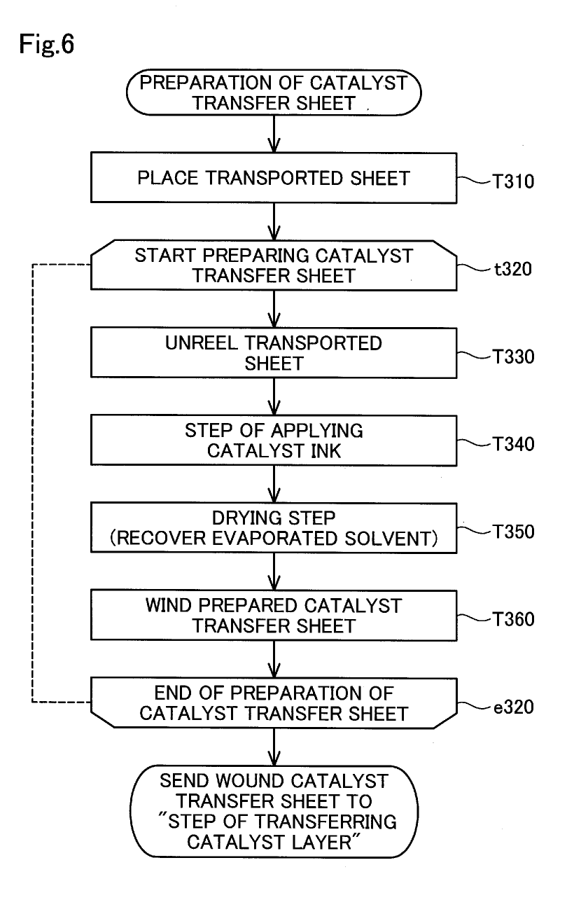

The overview of at least part of the steps of manufacturing a membrane electrode assembly has been described. The step of preparing a catalyst transfer sheet (step T300) will next be described in detail. FIG. 6 is a step diagram showing the step of preparing a catalyst transfer sheet (step T300). When the step of preparing a catalyst transfer sheet (step T300) starts, a provided transported sheet 11 is first placed in the catalyst transfer sheet preparation apparatus 10 (step T310). The following steps T330 to T360 are then repeatedly carried out on the placed transported sheet 11 from the front end to the rear end thereof. The repetition range is indicated by reference characters t320 and e320 in FIG. 6.

Within the repetition range, the following steps are repeated: The transported sheet is unreeled (step T330); the catalyst ink is applied (step T340); the dryer/recovery apparatus 30 dries the catalyst ink and recovers the dispersion solvent (step T350); and the catalyst transfer sheet 45 is wound (step T360). The steps T330 to T360 are continuously carried out in the presented order from the viewpoint of one location of the transported sheet 11 but are simultaneously carried out from the viewpoint of the entire catalyst transfer sheet preparation apparatus 10.

When the roll of transported sheet 11 provided in the step of providing a transported sheet (step T100) and placed in the catalyst transfer sheet preparation apparatus 10 in step T310 has undergone the step of preparing a catalyst transfer sheet (step T300), the wound catalyst transfer sheet is sent to the step of transferring a catalyst layer (step T400). The catalyst transfer sheet 45 is temporarily wound and sent to the step of transferring a catalyst layer in the description so that the catalyst transfer sheet 45 is readily handled. Instead, the two steps may be continuous steps with no difficulty.

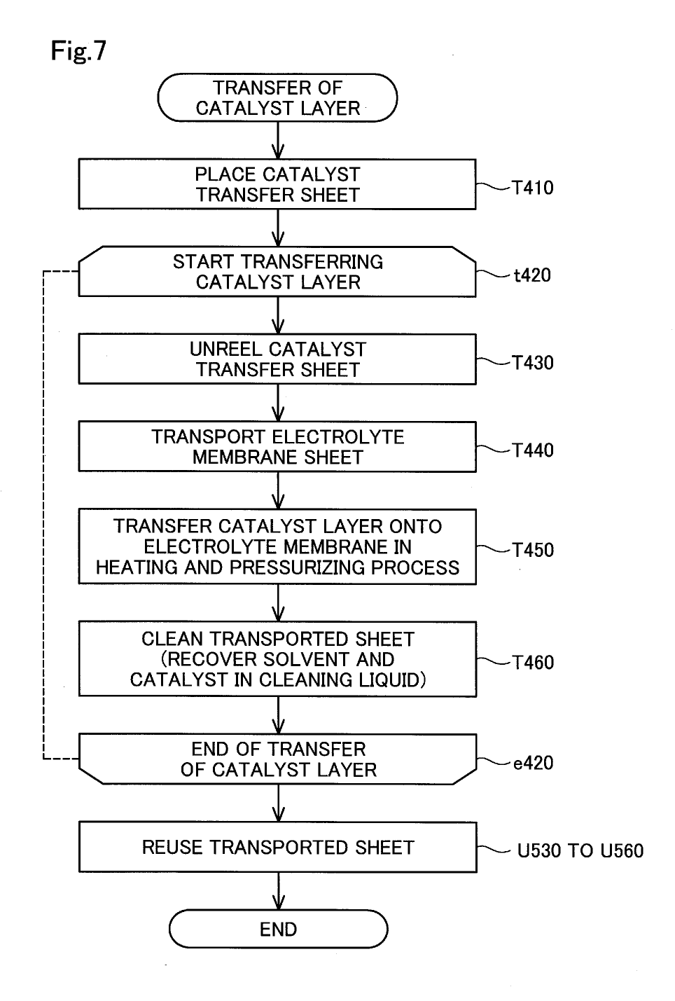

FIG. 7 shows the step of transferring a catalyst layer (step T400) in detail. When the step of transferring a catalyst layer starts, the catalyst transfer sheet 45 is first placed in the catalyst layer transfer apparatus 50 (step T410). The following steps T430 to T460 are then repeatedly carried out on the placed catalyst transfer sheet 45 from the front end to the rear end thereof. The repetition range is indicated by reference characters t420 and e420 in FIG. 7.

Within the repetition range, the following steps are repeated: The catalyst transfer sheet is unreeled (step T430); the electrolyte membrane sheet 60 is transported (step T440); the catalyst layer 25 is transferred onto the electrolyte membrane 62 in the heating and pressurizing process (step T450); and the cleaner 80 cleans the transported sheet and recovers the catalyst and the dispersion solvent (step T460). The steps T430 to T460 are continuously carried out in the presented order from the viewpoint of one location of the catalyst transfer sheet 45 but are simultaneously carried out from the viewpoint of the entire catalyst layer transfer apparatus 50.

In step T410, when the roll of catalyst transfer sheet 45 placed in the catalyst layer transfer apparatus 50 has undergone the step of transferring a catalyst layer (step T400), the used transported sheet 11 is recovered and reused (step U530 to U560). These steps have been already described with reference to FIG. 4. The transported sheet 11 having a usage count smaller than the quality assurance count is sent to the step of providing a transported sheet 11 (step T100).

According to the embodiment described above, in the step of transferring a cathode-side catalyst layer onto an electrolyte membrane, the transported sheet can be reused multiple times. Further, in this case, since the quality assurance count has been determined in advance, the transported sheet can be reused without undergoing a test or any other process as long as the usage count of the transported sheet is smaller than or equal to the quality assurance count.

Further, in the present embodiment, in the step of drying a catalyst ink, the dispersion solvent having been used to manufacture the catalyst ink can be largely recovered by the dryer/recovery apparatus 30, and the recovered dispersion solvent is reused to clean the used transported sheet 11 in the step of transferring a catalyst layer (step T400). As a result, the amount of dispersion solvent discharged in the steps of manufacturing a membrane electrode assembly can be reduced. Further, part of the dispersion solvent having been used in the cleaning process is used to manufacture the catalyst ink. The amount of consumption of a new dispersion solvent used to manufacture the catalyst ink can therefore be reduced. As the used dispersion solvent to be used to manufacture the catalyst ink, the dispersion solvent recovered by the dryer/recovery apparatus 30 can be directly used.

In addition, in the manufacturing method according to the present embodiment, the residue of the catalyst layer 25 transferred onto the electrolyte membrane sheet 60 is recovered by the cleaner 80 and used to manufacture the catalyst ink. The amount of discharged catalyst can therefore also be reduced. Further, since the recovered dispersion solvent is used to clean the residue of the catalyst, the cost of providing a new cleaning solution can be reduced, and the amount of clean solution discharged in the manufacturing steps can also be reduced. Therefore, resource saving can be achieved, and the manufacturing cost can also be reduced.

### C. Other Embodiments

In the embodiment described above, the bottom of the cleaner 80 is used as the storage tank, and the catalyst having deposited at the bottom is reused, but the catalyst may not be reused. The reason for this is that the amount of catalyst recovered in the cleaning process is very small as long as the amount of residue left when the catalyst layer 25 is transferred onto the electrolyte membrane sheet 60 can be reduced.

Further, in the embodiment described above, the coater 20 is brought onto the surface of the transported sheet 11 for the application of the catalyst ink. The catalyst ink may instead be applied in another approach. For example, the catalyst ink may be applied by using an application roller having a surface formed of a porous element. Still instead, the catalyst ink ejected out of the coater 20 and applied onto the surface of the transported sheet 11 may be scraped off with a scraper or any other tool so as to have a uniform thickness.

Instead of formation of the cathode-side catalyst layer, the present disclosure may be applied to formation of an anode-side catalyst layer and transfer of the anode-side catalyst layer to the electrolyte membrane. The disclosure is, of course, applicable not only to the formation and transfer of the cathode-side catalyst layer but to the formation and transfer of the anode-side catalyst layer. The catalyst layer 25 may be transferred onto the electrolyte membrane 62 by using a configuration other than the heating/pressuring rollers. For example, a press machine configured to perform fixed-area pressurization may be employed in place of the rollers. The catalyst layer 25 on the transported sheet 11 only needs to be transferred onto the electrolyte membrane 62, and using the back sheet 61 is not essential.

The dryer/recovery apparatus 30 only needs to recover the solvent evaporating from the catalyst ink, and the temperature, the pressure, and other factors that allow the evaporation of the solvent may be adjusted in accordance with the nature of the solvent used in the catalyst ink. In the embodiment described above, the solvent having evaporated onto the cooling tube 31 is cooled to a temperature lower than the dew point of the solvent and then recovered. Instead, a Peltier element or any other device may be used to cool the solvent. Still instead, the solvent having evaporated from the catalyst ink may be collected and pressurized to liquefy or may be caused to undergo adiabatic expansion so that the solvent is cooled to liquefy and then recovered. Still instead, the solvent having evaporated from the catalyst ink may be transported in the form of the evaporation gas from the dryer/recovery apparatus 30 to the cleaner 80, and the solvent may be allowed to liquefy during the transportation or in the cleaner 80.

The cleaner 80 uses the shower head 81 to spray the solvent to clean the surface of the transported sheet 11 in the embodiment described above, but the solvent-based cleaning may be performed in any other arbitrary form. For example, the transported sheet 11 to which a residue of the catalyst layer 25 has adhered may be dipped in a tank that stores the solvent, and ultrasonic vibration or any other action may be applied to the transported sheet 11 for removal of the residue of the catalyst layer 25. This approach may be combined with the cleaning based on the solvent sprayed from the shower head.

Regarding the recovery of the catalyst and the dispersion solvent therein in the cleaner 80, only one of the catalyst and the dispersion solvent may be recovered, or both the catalyst and the dispersion solvent may be recovered. The separation between the catalyst and the solvent may be performed based on deposition or by using a filter or any other component.

(1) As described above, one aspect of the present disclosure relates to a method for manufacturing at least a catalyst layer by using catalyst ink formed of a solid catalyst dispersed in a liquid solvent, the method including drying a sheet having undergone the process of applying the catalyst ink onto at least part of a surface of the sheet to a predetermined thickness to recover the solvent evaporating from the catalyst ink, cleaning the sheet having undergone the process of transferring a catalyst layer formed on the sheet after the solvent evaporates onto another member so that the catalyst layer is removed by using the recovered solvent as cleaning liquid to remove at least part of a residue of at least the catalyst ink left on the sheet, and using at least part of the cleaned sheet in the application of the catalyst ink.

(2) In the manufacturing method described above, the catalyst left in the recovered solvent or the solvent used to clean the sheet may be separated and recovered. The catalyst can therefore be used without waste. The catalyst may be recovered so that at least part of the left catalyst is recovered or the entire left catalyst is not necessarily recovered.

(3) In this case, the catalyst may be separated by storing the solvent used in the cleaning process in a storage tank and causing the catalyst to deposit onto the bottom of the storage tank. The catalyst can therefore be readily recovered with the amount of input energy reduced.

(4) In this case, at least part of the recovered catalyst may be used to manufacture the catalyst ink. The overall amount of catalyst used to manufacture the catalyst ink can therefore be reduced.

(5) In the manufacturing method described above, the solvent evaporating from the catalyst ink can be recovered by disposing a cooler that at least cools the solvent to a temperature lower than or equal to the dew point of the solvent in a position separate from the sheet to be dried and collecting the solvent having been cooled to be liquefied by the cooler. It is easy to recovery of the solvent and the solvent can therefore be readily used in other purposes.

(6) In the manufacturing method described above, at least part of at least one of the recovered solvent and the solvent recovered from the cleaning liquid used to clean the sheet may be used to manufacture the catalyst ink. The overall amount of solvent used to manufacture the catalyst ink can therefore be reduced.

(7) In the manufacturing method described above, the catalyst layer may be transferred from the sheet onto the other member at a transfer temperature higher than or equal to 130° C. but lower than or equal to 150° C., and a change in the dimension of the sheet at the transfer temperature may be limited to a value smaller than or equal to 0.6%. A sheet that satisfies the conditions described above can be reused with the quality of the cleaned sheet assured. The usage count when the dimension change after use becomes greater than 0.6% is measured and can be used as the quality assurance count, which is a criterion of the re-usage count of the sheet. In a case where the transfer temperature changes according to the physical properties of the catalyst layer and the material of the other member onto which the catalyst layer is transferred, the quality assurance count may be defined at that temperature. The conditions under which the sheet can be reused may include an additional condition in consideration of how easily the catalyst layer peels off the sheet, for example, in the case where the water contact angle is greater than 95 degrees.

(8) The present disclosure may be implemented as a method for manufacturing a catalyst layer by using catalyst ink or may be implemented as the method for manufacturing at least part of a membrane electrode assembly as in the embodiment described above. The present disclosure may instead be implemented as a manufacturing apparatus that carries out any of the methods. In addition, the present disclosure can be implemented as a method for recovering a transported sheet or a method for recovering a solvent in a catalyst.

What is claimed is:

1. A method for manufacturing at least a catalyst layer by using catalyst ink formed of a solid catalyst dispersed in a liquid solvent, the method comprising:
drying a sheet having undergone a process of applying the catalyst ink onto at least part of a surface of the sheet to a predetermined thickness to recover the solvent evaporating from the catalyst ink;
cleaning, by using the recovered solvent as cleaning liquid, the sheet to remove at least part of a residue of at least the catalyst ink left on the sheet, the sheet having undergone a process of transferring the catalyst layer formed on the sheet after the solvent evaporates onto another member to remove the catalyst layer; and
reusing at least part of the cleaned sheet in the application of the catalyst ink.

2. The manufacturing method in accordance with claim 1, wherein the catalyst left in the recovered solvent or the solvent used to clean the sheet is separated and recovered.

3. The manufacturing method in accordance with claim 2, wherein the catalyst is separated by storing the solvent in a storage tank and causing the catalyst to deposit onto a bottom of the storage tank.

4. The manufacturing method in accordance with claim 3, wherein at least part of the recovered catalyst is used to manufacture the catalyst ink.

5. The manufacturing method in accordance with claim 2, wherein at least part of the recovered catalyst is used to manufacture the catalyst ink.

6. The manufacturing method in accordance with claim 1, wherein the solvent evaporating from the catalyst ink is recovered by disposing a cooler that at least cools the solvent to a temperature lower than or equal to a dew point of the solvent in a position separate from the sheet to be dried and collecting the solvent having been cooled to be liquefied by the cooler.

7. The manufacturing method in accordance with claim 1, wherein at least part of at least one of the recovered solvent and the solvent recovered from the cleaning liquid used to clean the sheet is used to manufacture the catalyst ink.

8. The manufacturing method in accordance with claim 1, wherein the catalyst layer is transferred from the sheet onto the other member at a transfer temperature higher than or equal to 130° C. but lower than or equal to 150° C., and a change in dimension of the sheet at the transfer temperature is smaller than or equal to 0.6%.

9. An apparatus that manufactures at least a catalyst layer by using catalyst ink formed of a solid catalyst dispersed in a liquid solvent, the apparatus comprising:
a dryer/recovery apparatus that dries a sheet having undergone a process of applying the catalyst ink onto at least part of a surface of the sheet to a predetermined thickness to recover the solvent evaporating from the catalyst ink; and
a cleaner that cleans, by using the recovered solvent as cleaning liquid, the sheet to remove at least part of a residue of at least the catalyst ink left on the sheet, the sheet having undergone a process of transferring a catalyst layer formed on the sheet after the solvent is recovered onto another member to remove the catalyst layer,
wherein at least part of the cleaned sheet is reused in the application of the catalyst ink.
